(19) United States
(12) Patent Application Publication
(10) Pub. No.: US 2006/0188313 A1
(43) Pub. Date: Aug. 24, 2006

(54) Noise reduction structure for solenoid assembly

(75) Inventor: Takeshi Ishii, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/359,344

(22) Filed: Feb. 21, 2006

(30) Foreign Application Priority Data
Feb. 23, 2005 (JP) 2005-047824

(51) Int. Cl. B41J 11/24

(52) U.S. Cl. 400/641; 400/636

(57) ABSTRACT

A printer (10) has a body (11) with a solenoid assembly that includes a swingable plate (42). The swingable plate (42) can change posture between an engaged posture (S2), where the swingable plate (42) is electromagnetically attracted to a solenoid (412) and an engagement release posture (S1), where the solenoid (412) is demagnetized so that the swingable plate (42) is moved back by a coil spring (43) to perform a given operation. A noise reduction structure reduces a hitting sound of the swingable plate (42) relative to a stopper in connection with the change from the engaged posture (S2) to the engagement release posture (S1). In the noise reduction structure, the solenoid assembly is mounted to a drive plate (30) fixed to a frame of the body (11), and a positioning protrusion (212b) integrated with a 3-dimensional frame (20) is used as the stopper.

### BACKGROUND OF THE INVENTION

1. Field of the Invention

The present invention relates to a noise reduction structure for reducing operation noise of a solenoid assembly housed in an apparatus body of a given apparatus, and more particularly to a noise reduction structure for a solenoid assembly, suitable for application to an image forming apparatus.

2. Description of the Related Art

Typically, a solenoid assembly comprises a core, a solenoid wound around the core, and a flapper adapted to be electromagnetically attracted to the core when the solenoid is magnetized in response to current supply thereto, and released from the electromagnetic attraction when the solenoid is demagnetized in response to stopping the current supply. The flapper is supported in a rotatable manner around a given support shaft, and an end of the flapper disposed in opposed relation to the core is biased in a direction away from the core by given biasing means. In this connection, a biasing force of the biasing means is set at a value less than an electromagnetic attraction force of the energized core so as to allow the flapper to be changed in posture between an electromagnetically attracted posture where the end of the flapper is electromagnetically attracted to the core and a spaced-apart posture where the end of the flapper is spaced apart from the demagnetized core by the biasing force of the biasing means.

Further, a stopper is disposed in the vicinity of the flapper to determine a position of the flapper set in the spaced-apart posture, so as to prevent overrun of the flapper which would otherwise be caused by the biasing force of the biasing means when the solenoid is demagnetized. In view of excellent structural simplicity and easiness in downsizing, this type of solenoid assembly is suitably used in various apparatuses as a driving source for operating a given movable member.

In this type of solenoid assembly, the flapper is electromagnetically attracted to the core at a high speed when the solenoid is magnetized, and struck against the stopper at a high speed when the solenoid is demagnetized. In either occasion, loud hitting sound is generated. Such hitting sound is likely to become the cause of noise in a quiet business office.

As measures against this problem, some noise reduction structures for a solenoid assembly have been proposed as disclosed in Japanese Unexamined Patent Publication Nos. 07-295318, 10-270242 and 2000-124028. All of the noise reduction structures are intended for a solenoid valve used in an image forming apparatus.

In a noise reduction structure disclosed in Japanese Unexamined Patent Publication No. 07-295318, a solenoid assembly is provided for a sheet-feeding roller adapted to pick up a sheet from a storage section in an image forming apparatus, and a flapper is used in a switching operation of a clutch for controllably activating and stopping a rotation of the sheet-feeding roller. This noise reduction structure employs a sound-absorbing material made of foamed silicone elastomer and attached onto a hit surface of a core. Thus, even if the flapper is electromagnetically drawn by a magnetized solenoid at a high speed, hitting sound is absorbed by the sound-absorbing material attached on the hit surface of the core, so as to prevent noise generation.

In a noise reduction structure disclosed in Japanese Unexamined Patent Publication No. 10-270242, a solenoid assembly is provided for a clutch operation of a sheet-feeding roller in an image forming apparatus, as with Japanese Unexamined Patent Publication No. 07-295318. In addition to a cushioning material similar to the sound-absorbing material in Japanese Unexamined Patent Publication No. 07-295318, this noise reduction structure includes a damping mechanism for allowing a flapper to be reduced in a speed away from the solenoid when a solenoid is demagnetized. This noise reduction structure makes it possible to suppress generation of hitting sound both when the flapper is electromagnetically attracted to the core and when the flapper is moved away from the core by a biasing force of biasing means in response to demagnetization of the solenoid.

A noise reduction structure disclosed in Japanese Unexamined Patent Publication No. 2000-124028 is based on the same background as those in Japanese Unexamined Patent Publication Nos. 07-295318 and 10-270242, in that a solenoid assembly subject to noise reduction is used in a clutch mechanism for a sheet-feeding roller in an image forming apparatus. In addition to measures against hitting sound of a flapper, this noise reduction structure is designed to provide a sound-absorbing material between the flapper and a support member for supporting the flapper, so as to prevent generation of noise due to wobbling between the flapper and the support member.

However, each of the sound reduction structures disclosed in the above publications is designed to provide an additional component, such as the sound-absorbing material, to the solenoid valve. This increases the number of components and a process time for assembling to cause a problem about increase in production cost.

Moreover, the solenoid assembly is generally fixed to a dedicated support plate provided in a frame of the image forming apparatus. Thus, when the flapper hits the stopper, a mechanical shock during the hitting is likely to cause resonance in the support plate even if a sound-absorbing material is attached to a hit surface of the stopper, to cause a problem about difficulty in effectively reducing noise.

### SUMMARY OF THE INVENTION

In view of the above circumstances, it is an object of the present invention to provide a noise reduction structure for a solenoid assembly which can maximally suppress noise in connection with driving of the solenoid valve while suppressing increase in production cost.

According to an aspect of the present invention, in an apparatus having an apparatus body provided with a solenoid assembly including a flapper designed to be changed in posture between an electromagnetically attracted posture where a solenoid is magnetized to thereby attract the flapper electromagnetically to the solenoid and a release posture where the solenoid is demagnetized to thereby move the flapper back by given biasing means and stop it by contact with a given stopper, there is provided a noise reduction structure for reducing hitting sound of the flapper relative to the stopper in connection with the postural change from the an electromagnetically attracted posture to the release posture. The solenoid assembly is mounted to a solenoid-mounting plate fixed to a frame of said apparatus body. The stopper is provided in the frame in an integrated manner.

### BRIEF DESCRIPTION OF THE DRAWINGS

FIG. 1 is an explanatory sectional front view showing an internal structure of a printer employing a noise reduction structure for a solenoid assembly, according to one embodiment of the present invention.

FIG. 2 is a perspective view showing a frame of the printer.

FIG. 3 is an explanatory exploded perspective view showing a structure for mounting a braking assembly and a latch gear to a drive plate.

FIG. 4 is an explanatory perspective view showing the structure for mounting the braking assembly and the latch gear to the drive plate after assembling.

FIG. 5 is a sectional view taken along the line A-A in FIG. 4.

FIG. 6 is a perspective view showing one actual example of an arrangement of a registration roller pair.

FIG. 7A is an explanatory diagram of an operation of the noise reduction structure according to the embodiment of the present invention, wherein a swingable member is set in an engagement release posture.

FIG. 7B is an explanatory diagram of an operation of the noise reduction structure according to the embodiment of the present invention, wherein the swingable member is set in an engaged posture.

### DETAILED DESCRIPTION OF THE PREFERRED EMBODIMENTS

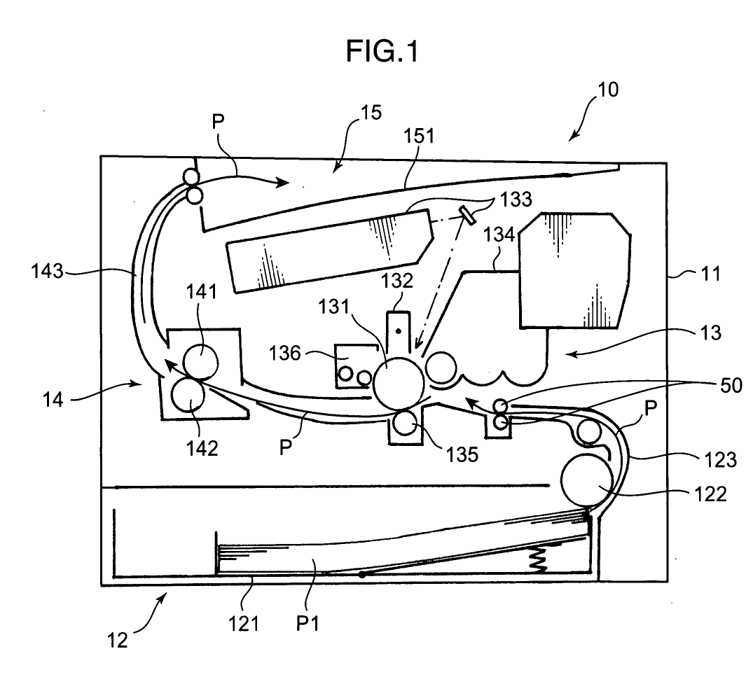

FIG. 1 is an explanatory sectional front view showing an internal structure of a printer employing a noise reduction structure for a solenoid assembly, according to one embodiment of the present invention. As shown in FIG. 1, the printer (image forming apparatus) 10 comprises an apparatus body 11 which houses a sheet storage section 12 for storing a sheet stack P1 to be subjected to a printing process, an image forming section 13 for performing an image forming process including a transfer process to sheets P picked up one-by-one from the sheet stack P1 stored in the sheet storage section 12, and a fixing section 14 for performing a fixing process to the sheet P after being subjected to the transfer process through the image forming section 13. The printer 10 further includes a sheet ejection section 15 provided at a top portion of the apparatus body 11 to receive the sheet P after being subjected to the fixing process through the fixing section 14.

The sheet storage section 12 is provided with a given number (one in this embodiment) of sheet cassettes 121 in a detachable manner with respect to the apparatus body 11. A pickup roller 122 adapted to pick up sheets P from the sheet stack P1 one-by-one is disposed on an upstream end (right side in FIG. 1) of the sheet cassette 121. The sheet P picked up from the sheet cassette 121 according to driving of the pickup roller 122 is fed to the image forming section 13 through a sheet-feeding passage 123 and a registration roller pair (sheet-feeding roller) 50 disposed on a downstream end of the sheet-feeding passage 123.

The image forming section 13 serves as a means to form an image based on image information transmitted from a computer or the like and transfer the image to the sheet P, and comprises a photosensitive drum 131 adapted to be rotated about a drum axis extending in a direction orthogonal to the drawing sheet of FIG. 1. The image forming section 13 further includes an electrostatic-charger device 132, a light-exposure device 133, an image-development device 134, a transfer roller 135 and a cleaning device 136, which are disposed along an outer peripheral surface of the photosensitive drum 131 and in a clockwise direction from a position immediately above the photosensitive drum 131.

The photosensitive drum 131 is used for forming an electrostatic image and a toner image on the outer peripheral surface thereof. The outer peripheral surface is formed with a hardness and smooth amorphous silicon layer to serve as a surface suitable for forming an image thereon.

The electrostatic-charger device 132 is operable to form a uniform charge layer on the outer peripheral surface of the photosensitive drum 131 which is being rotated about the drum axis in the clockwise direction. In the embodiment illustrated in FIG. 1, the electrostatic-charge device 132 employs a system of giving charges onto the outer peripheral surface of the photosensitive drum 131 by means of corona discharge. Instead of this type of electrostatic charger 132, the outer peripheral surface of the photosensitive drum 131 may be electrostatically charged using an electrostatic charge roller which has an outer peripheral surface adapted to be brought into contact with the outer peripheral surface of the photosensitive drum 131 so as to give charges onto the outer peripheral surface of the photosensitive drum 131 while being rotationally driven by the photosensitive drum 131.

The light-exposure device 133 is operable to irradiate the outer peripheral surface of the photosensitive drum 131 which is being rotated, with a laser light having intensity varied based on image data transmitted from an external device, such as a computer, so as to eliminate charges in a region of the outer peripheral surface of the photosensitive drum 131 irradiated with the laser light to form an electrostatic latent image on the outer peripheral surface of the photosensitive drum 131.

The image-development device 134 is operable to supply toner onto the outer peripheral surface of the photosensitive drum 131 so as to attach the toner on a region formed as the electrostatic latent image to form a toner image on the outer peripheral surface of the photosensitive drum 131.

The transfer roller 135 is operable to transfer the positively-charged toner image formed on the outer peripheral surface of the photosensitive drum 131, to the sheet P fed to a position immediately below the photosensitive drum 131. The transfer roller 135 is designed to give negative charges having a reverse polarity relative to charges of the toner image, to the sheet P.

Thus, the sheet P reaching the position immediately below the photosensitive drum 131 is pressed and nipped between the transfer roller 135 and the photosensitive drum 131, and the toner image on the outer peripheral surface of the photosensitive drum 131 is peeled toward a surface of the positively-charged sheet P. In this manner, the sheet P is subjected to the transfer process.

The cleaning device 136 is operable to remove toner remaining on the outer peripheral surface of the photosensitive drum 131 after completion of the transfer process, so as to clean the outer peripheral surface of the photosensitive drum 131. The outer peripheral surface of the photosensitive drum 131 cleaned by the cleaning device 136 will be rotated toward the electrostatic-charge device 132 again to perform a next image forming process.

The fixing section 14 serves as a means to heat the toner image on the sheet P subjected to the transfer process through the image forming section 13, so as to subject the sheet P to the fixing process. The fixing section 14 includes a heating roller 141 internally having an electric heating element, and a pressing roller 142 disposed below the heating roller to allow an outer peripheral surface thereof to be located in opposed relation to an outer peripheral surfaces of the heating roller 141. The sheet P after completion of the transfer process is subjected to the fixing process based on heat from the heating roller 141 obtained during the course of passing through a nip region between the heating roller 141 which is being drivingly rotated in the clockwise direction about a roller axis, and the pressing roller 142 which is being followingly or drivenly rotated in a counterclockwise direction about a roller axis. The sheet P subjected to the fixing process will be ejected to the sheet ejection section 15 through a sheet-ejecting passage 142.

The sheet ejection section 15 is formed by concaving the top portion of the apparatus body 11 to define a concaved depression with a bottom serving as a sheet tray for receiving the ejected sheet P.

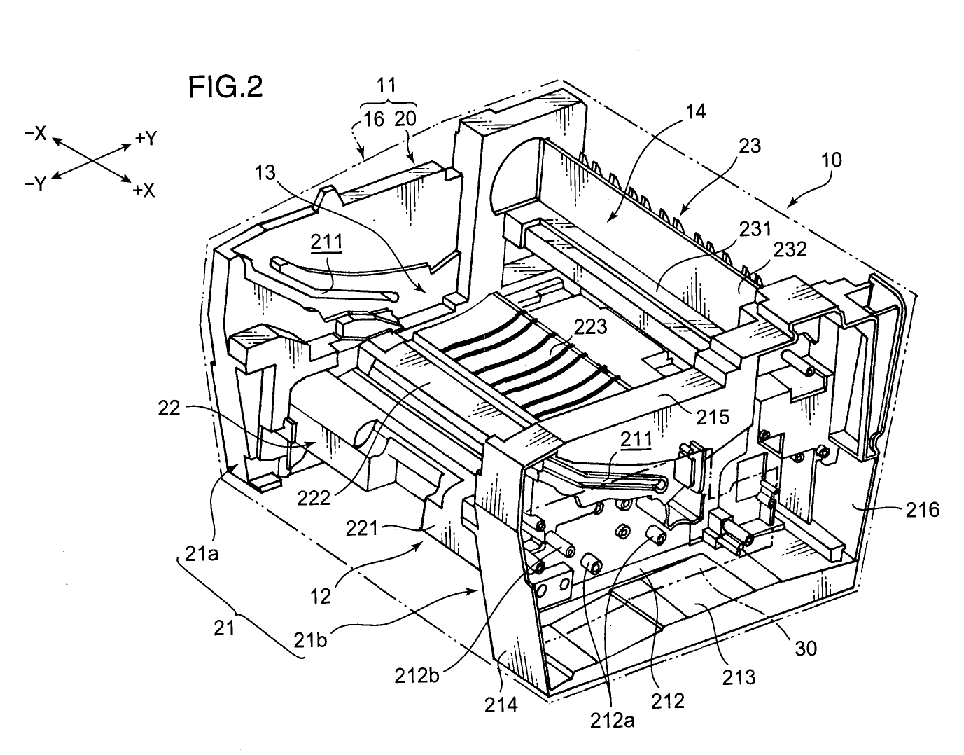

FIG. 2 is a perspective view showing a frame of the printer 10. In the following description, “rightward/leftward direction”, “frontward/rearward direction”, “leftward (direction)”, “rightward (direction)”, “frontward (direction)” and “rearward (direction)” correspond, respectively, to the X-X direction, the Y-Y direction, the −X direction, the +X direction, the −Y direction and the +Y direction, in FIG. 2. In FIG. 2, the rightward/leftward direction is reversed relative to that in FIG. 1.

The printer 10 in this embodiment is formed by mounting various devices constituting each of the sheet storage section 12, the image forming section 13, the fixing section 14 and the sheet ejection section 15 illustrated in FIG. 1, to a 3-dimensional frame 20 as shown in FIG. 2, and attaching a given exterior member indicated by the two-dot chain line, to an outer surface of the 3-dimensional frame 20. The apparatus body 11 comprises the 3-dimensional frame 20 and the exterior member 16.

The 3-dimensional frame 20 is made of a synthetic resin, such as ABS (acrylonitrile-butadiene-styrene copolymer) or PC (polycarbonate), or a mixture or alloy material thereof. The 3-dimensional frame 20 includes a pair of right and left side frames 21, a partition frame 22 bridged between respective lower portions of the pair of side frames 21 to partition between the sheet storage section 12 and the image forming section 13, and a fixing-section support frame 23 disposed on a rearward/upward side relatively to the partition frame 22 and bridged between the pair of side frames 21 to support the fixing section 14 and serve as a part of a wall surface of the sheet-ejecting passage 143.

The side frames 21 consist of a left frame 21a integrated with a left end of the partition frame 22, and a right frame 21b formed approximately plane-symmetrically with the left frame 21a and integrated with a right end of the partition frame 22.

Each of opposed inner surfaces of the left and right frames 21a, 21b is grooved from a front upper edge thereof rearward and obliquely downward to form a drum-mounting groove 211. Each of opposite ends of a drum shaft (not shown) of the photosensitive drum 131 (FIG. 1) is fitted into a corresponding one of the drum-mounting groove 211 to allow the photosensitive drum 131 to be mounted and supported between the left and right frames 21a, 21b.

In the same manner, each of the electrostatic-charger device 132, the light-exposure device 133, the image-development device 134, the transfer roller 135 and the cleaning device 136 is mounted at an appropriate position between the left and right frames 21a, 21b through a given support structure. The detailed description of this structure will be omitted.

The partition frame 22 includes a roller support portion 221 formed on a frontward side thereof to support the pickup roller 122 (FIG. 1), an upstream sheet guide portion 222 extending rearward from the roller support portion 221 to guide the sheet P to the photosensitive drum 131, and a downstream sheet guide portion 223 disposed slightly spaced apart from the upstream sheet guide portion 222 in the rearward direction to guide the sheet P after completion of the transfer process to the fixing section 14.

The sheet P picked up from the sheet stack P1 stored in the sheet cassette 121 (FIG. 1), by driving of the pickup roller 122, is introduced to the fixing section 14 through the registration roller pair 50 (FIG. 1), the roller support portion 221, the upstream sheet guide portion 222, the nip region between the photosensitive drum 131 and the transfer roller 135, and the downstream sheet guide portion 223.

The fixing-section support frame 23 has a L shape in side view, and includes a fixing-section support frame portion 231 extending approximately in a horizontal direction to support the fixing section 14, and an upright frame portion 232 standing upright from a rear edge of the fixing-section support frame portion 231. The upright frame portion 232 has a rear wall surface serving as a part of the sheet-ejecting passage 143 for ejecting the sheet P after completion of the fixing process to the sheet tray 151.

The right frame 21b includes a flat-shaped frame plate 212 formed with the drum-mounting frame 211, a bottom frame 213 protruding rightward from a bottom edge of the frame plate 212 and extending in the frontward/rearward direction, a front frame 214 protruding rightward from a front edge of the frame plate 212 and extending vertically, a top frame 215 protruding rightward from a top edge of the frame plate 212 and extending in the frontward/rearward direction, and a rear frame 216 protruding rightward from a rear edge of the frame plate 212. Based on this frame structure, the right frame 21b has a sufficient strength.

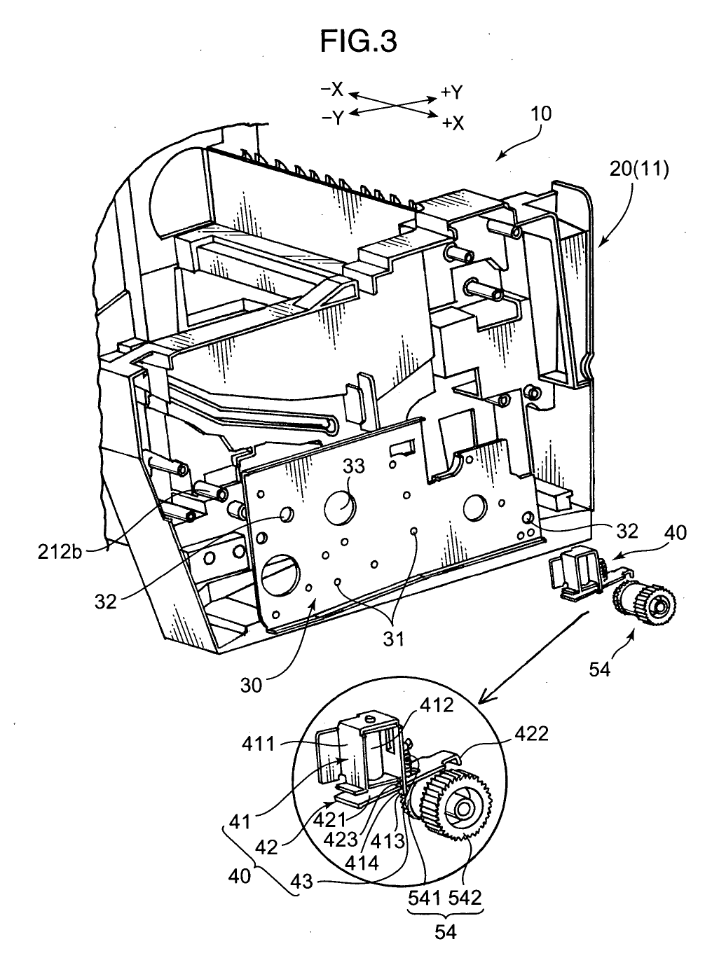

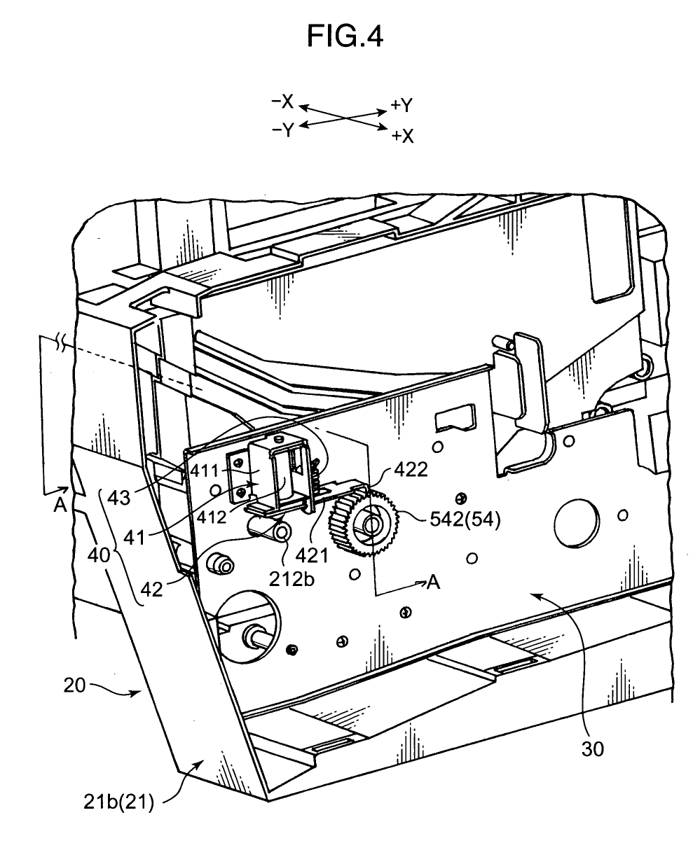

A drive plate (solenoid-mounting plate) 30 (see FIGS. 3 and 4; indicated by the two-dot chain line in FIG. 2) is housed in a space surrounded by the bottom frame 213, front frame 212, top frame 215 and the rear frame 216 of the right frame 21b. This drive plate 30 is provided as a means to mount a latch gear 54 (FIG. 3) associated with in one of the registration roller pair 50, a braking assembly 40 for use in inhibiting an axial rotation of the latch gear 54 and releasing the inhibition, and others.

FIGS. 3 and 4 are explanatory perspective views showing a structure for mounting the braking assembly 40 and the latch gear 54 to the drive plate 30. FIG. 3 is an exploded perspective view, and FIG. 4 is a perspective view after assembling. The circled area in FIG. 3 is an enlarged view of the braking assembly 40. In FIGS. 3 and 4, respective directions indicated by X and Y [X: rightward/leftward direction (−X: leftward (direction), +X: rightward (direction)), Y: frontward/rearward direction (−Y: frontward (direction), +Y: rearward (direction))] are the same as those in FIG. 2.

As shown in FIGS. 3 and 4, the drive plate 30 is formed with a plurality of mounting holes 31, a positioning hole 32 and a latch-gear mounting hole 33 for mounting the latch gear 54 at appropriate positions. The frame plate 212 of the right frame 21b is provided with a plurality of bushes 212a (FIG. 2) protruding therefrom at respective positions corresponding the mounting holes 31, and a columnar-shaped positioning protrusion (stopper) 212b protruding therefrom at a position corresponding to the positioning hole 32.

The positioning hole 32 is fitted onto the positioning protrusion 212b, and then a plurality of screws are driven, respectively, into the bushes 212b through the corresponding mounting holes 31 to fasten the drive plate 30 to the right frame 21b.

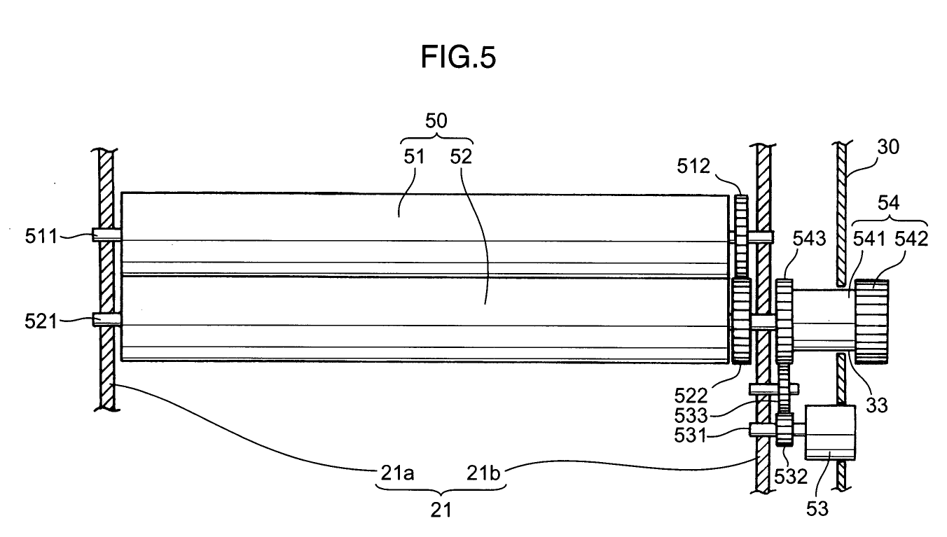

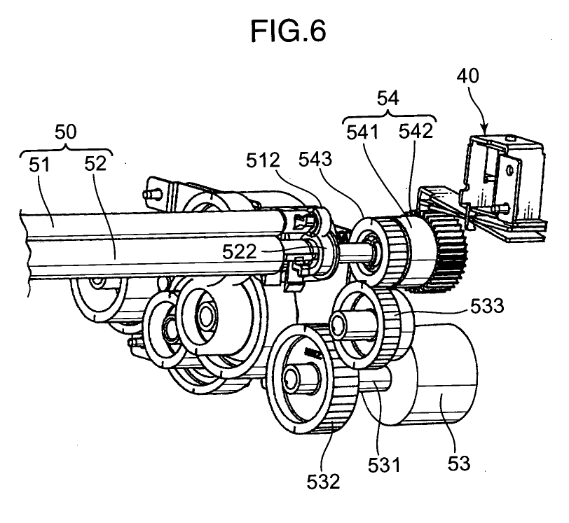

The latch gear 54 is one component associated with the registration roller pair 50. The registration roller pair 50 will be described in detail below based on FIGS. 5 and 6 and with reference to FIGS. 1 to 4 according to need. FIG. 5 is a sectional view taken along the line A-A in FIG. 4, and FIG. 6 is a perspective view showing one actual example of an arrangement of the registration roller pair 50.

The registration roller pair 50 comprises an upper roller 51 bridged between the right and left frame 21a, 21b, and a lower roller 52 bridged between the right and left frame 21a, 21b on the under side of the upper roller 51, in such a manner that respective outer peripheral surfaces of the upper roller 51 and the lower roller 52 are kept in contact with one another.

The upper roller 51 has an upper roller shaft 511 adapted to be rotated concentrically and integrally therewith, and the lower roller 52 has a lower roller shaft 521 adapted to be rotated concentrically and integrally therewith. The upper roller shaft 511 has opposite ends supported, respectively, by the right and left frame 21a, 21b in a penetrating manner, and the lower roller shaft 521 has opposite ends supported, respectively, by the right and left frame 21a, 21b in a penetrating manner.

An upper roller gear 512 is fitted onto the end of the upper roller shaft 511 on the side of the right frame 21b in such a manner as to be rotated concentrically and integrally with the upper roller shaft 511, and a lower roller gear 522 engaged with the upper roller gear 512 is fitted onto the end of the lower roller shaft 521 on the side of the right frame 21b in such a manner as to be rotated concentrically and integrally with the lower roller shaft 521. A driving rotation of the lower roller 52 is transmitted to the upper roller 51 through the lower roller shaft 521, the lower roller gear 522, the upper roller gear 512 and the upper roller shaft 511. Thus, the upper roller 51 is drivenly rotated according to the driving rotation of the lower roller 52.

The latch gear 54 is concentrically attached to the right end of the lower roller shaft 521. The latch gear 54 includes a cylindrical portion 541, and a latch portion 542 formed at one end (right end in FIG. 5) of the cylindrical portion 541 to have a diameter greater than that of the cylindrical portion 541. The latch portion 542 is formed with a plurality of latch teeth along a circumferential direction at even pitches. The cylindrical portion 541 is inserted through the latch-gear mounting hole 33 of the drive plate 30 to retainingly attach the latch gear 54 to the right end of the lower roller shaft 521 in such a manner as to be rotated integrally with the lower roller shaft 521.

A driving motor 53 is disposed on the right side relative to the right frame 21b and slightly below the latch gear 54 to drivingly rotate the lower roller 52. A driving gear 532 is fitted onto a driving shaft of the driving motor 53 concentrically and integrally. Further, a driven gear 543 is formed with the latch gear 54 integrally and concentrically at the left end (in FIG. 5) of the cylindrical portion 541, and an idle gear 533 is interposed between the driving gear 532 and the driven gear 543. Thus, when the driving motor 53 is activated, a driving force of the driving motor 53 will be transmitted to the latch gear 54 through the driving shaft 531, the driving gear 532, the idle gear 533 and the driven gear 543.

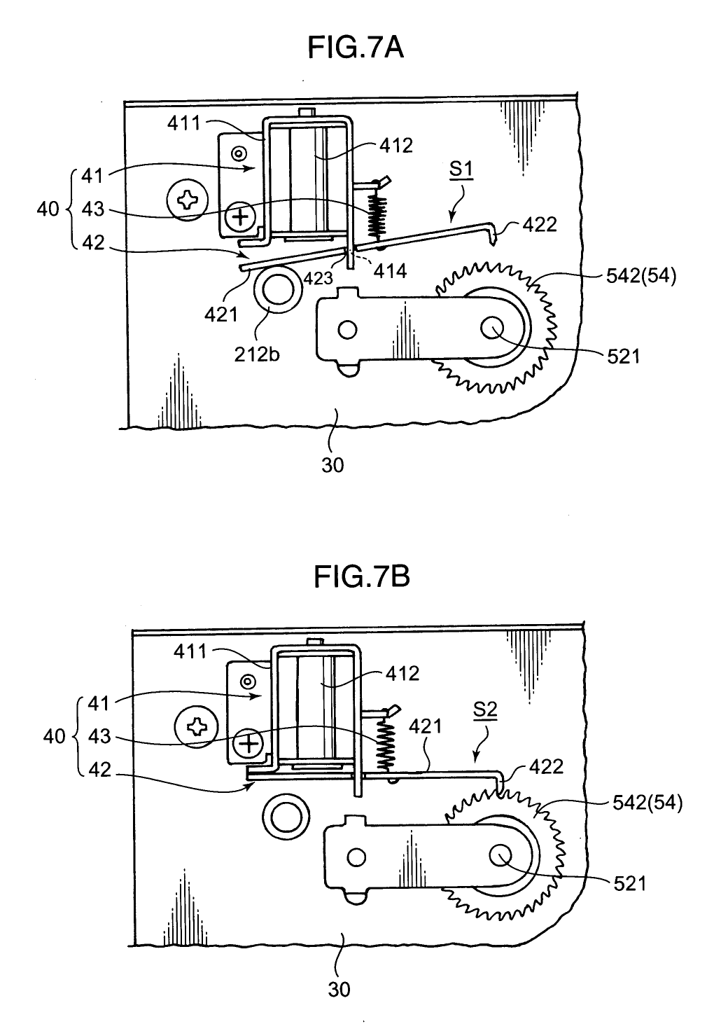

The cylindrical portion 541 of the latch gear 54 incorporates a torque limiter (not shown) for frictionally transmitting a rotation of the latch gear 54 to the lower roller shaft 521. Thus, in a normal state, a rotation of the latch gear 54 is transmitted to the lower roller 52 through the lower roller shaft 521. When a swingable plate 42 is set in an engaged posture (see FIG. 7) to inhibit the rotation of the latch gear 54, the cylindrical portion 541 of the latch gear 54 is idly rotated relative to the lower roller shaft 521 so as to preclude a driving rotation of the driving motor 53 from being transmitted to the lower roller 52.

In the above registration roller pair 50, a diameter ratio between the upper roller 51 and the lower roller 52 and a gear ratio between the upper roller gear 512 and the lower roller gear 522 (ratio between the respective numbers of teeth of the upper roller gear 512 and the lower roller gear 522) are appropriately arranged in such as manner as to allow a circumferential velocity of the upper roller 51 to be equal to a circumferential velocity of the lower roller 52.

The braking assembly 40 is operable, when a power supply to the driving motor 53 is stopped, to inhibit an inertial rotation of the registration roller pair 50 in conjunction with stop of the power supply, so as to reliably set a leading edge of the sheet P standing ready to be fed next, in a correct position. As shown in the circled area of FIG. 3, the braking assembly 40 comprises a solenoid device 41, and a swingable plate (flapper) 42 associated with the solenoid device 41 in such a manner as to be selectively swung both in normal and reverse directions or in a seesaw manner, and a coil spring 43 for giving a biasing force to the swingable plate 42 to serve as a biasing member.

The solenoid device 41 includes a box-shaped casing 411, and a solenoid 412 housed in the casing in a vertical posture and internally provided with a core. When the solenoid 421 is magnetized in response to current supply thereto, the swingable plate is electromagnetically attracted to the solenoid 421. Then, when the solenoid 412 is demagnetized in response to stop of the current supply, the electromagnetically attracted state of the swingable plate 42 to the solenoid is released.

The swingable plate 42 has a swingable-plate body 421 swingably supported by the casing 411, and an engagement pawl 422 integrally formed with the swingable-plate body 42 to extend downward from a rear end of the swingable-plate body 421. The engagement pawl 422 is adapted to be engaged with either one of the latch teeth of the latch portion 542 of the latch gear 54.

An approximately central region of the swingable-plate body 421 in the frontward/rearward direction is cut out from respective right and left edges thereof to form a pair of approximately U-shaped cutout grooves 423. Further, the casing 411 has a pair of mounting fingers 413 extending downward from respective right and left ends of a rear wall thereof, and opposed edges of the pair of mounting fingers 413 are cut out to form a pair of cutout grooves 414 each having a convex shape capable of being fitted into a corresponding of the cutout grooves 423 of the swingable plate 42. Thus, the cutout grooves 414, 423 of the casing 411 and the swingable plate 42 can be fitted to each other to allow the swingable plate 42 to be mounted to the casing 411 in such a manner as to be selectively swung in a seesaw manner.

The coil spring 43 is interposed between a protrusion protruding rearward from the rear wall of the casing 411 and a portion of the swingable plate body 421 located rearward relative to the cutout grooves 423, in a tensioned condition. Thus, in the state when the solenoid 412 is demagnetized, the swingable plate 42 is set in an engagement release posture (release posture) S1 (FIG. 7A) where the swingable plate 42 is swung in a counterclockwise direction about the cutout grooves 414 by the biasing force of the coil spring 43. Then, when the solenoid 12 is magnetized, the swingable plate 42 is electromagnetically attracted to the solenoid 412, and set in an engaged posture (electromagnetically attracted posture) S2 (FIG. 7B) where the swingable plate 42 is swung in a clockwise direction about the cutout grooves 414.

As shown in FIG. 4, the above braking assembly 40 is fixed to a region of the drive plate 30 located above an approximately intermediate position between the positioning protrusion 212b of the right frame 21b and the latch gear 30 by means of screw cramp or the like, in such a manner that the engagement pawl 422 of the swingable plate 42 is disposed in opposed relation to the latch portion 542 of the latch gear 54, and an front end of the swingable-plate body 421 is disposed in opposed relation to the positioning protrusion 212b.

In the noise reduction structure according to this embodiment, the positioning protrusion 212b protruding from the side frame 21 or a heavy member is used as a stopper adapted to allow the swingable plate 42 of the braking assembly 40 set in the engagement release posture S1 to be stopped by contact therewith.

FIG. 7A is an explanatory diagram of an operation of the noise reduction structure (i.e. the braking assembly 40, the positioning protrusion 212b and the latch gear 54) according to this embodiment, wherein the swingable plate 42 is set in the engagement release posture S1. FIG. 7B is an explanatory diagram of an operation of the noise reduction structure according to this embodiment, wherein the swingable plate 42 is set in the engaged posture S2.

In the state illustrated in FIG. 7A, the swingable plate 42 is biased in the counterclockwise direction about the cutout grooves 414, 423 by the biasing force of the coil spring 43, and thereby set in the engagement release posture S1 where the front end (left end in FIG. 7) of the swingable-plate body 421 is stopped by contact with the positioning protrusion 212b protruding from the right frame 21b, and the engagement pawl 422 of the swingable plate 42 is spaced apart from the latch portion 542 of the latch gear 542. Thus, the latch gear 54 can be rotated by driving of the driving motor 53 (FIG. 5).

In this state, when a given current is supplied to the solenoid 412 of the solenoid device 41, the solenoid 412 is magnetized, and an electromagnetic attraction force of the solenoid 412 acts on a front portion of the swingable plate 42. By the action of the electromagnetic attraction force, the swingable plate 42 is swung against the biasing force of the coil spring 43 in the clockwise about the cutout grooves 414, 423, and finally set in the engaged posture S2 where the front portion of the swingable-plate body 421 is electromagnetically attracted to the solenoid 412, as shown in FIG. 7B. In conjunction with this postural change, the engagement pawl 422 of the swingable plate 42 is engaged with one of the latch teeth of the latch portion 542 of the latch gear 54 to inhibit a rotation of the latch gear 54 around to the lower roller shaft 521.

Then, in the state after the swingable plate 42 is set in the engaged posture S2, when the solenoid 412 is demagnetized in response to shutoff of the current supply to the solenoid 412, the swingable plate 42 is swung in the counterclockwise direction about the cutout grooves 414, 423 by the biasing force of the coil spring 43, and returned to the engagement release posture S1, as shown in FIG. 7A. In this operation, the front end of the swingable-plate body 421 hits the positioning protrusion 212 serving as a stopper at a high speed.

However, the positioning protrusion 212b is designed to protrude integrally from the right frame 21b which is one of the integrated components of the 3-dimensional frame 20 as a heavy member. Thus, as compared with a case where the stopper is attached to or formed with the drive plate 30 which is a fairly lightweight member, hitting sound caused by the above hitting can be dispersed over and totally absorbed by the 3-dimensional frame 20 to prevent generation of harsh loud sound so as to reliably obtain a noise reduction effect.

As mentioned above in detail, in the noise reduction structure for the solenoid assembly 41 according to the above embodiment, a solenoid assembly (the braking assembly 40) comprising the swingable plate 42 adapted to be changed in posture between the electromagnetically attracted posture (engaged posture S2) where the solenoid 412 is magnetized and thereby the swingable plate 42 is electromagnetically attracted to the solenoid 412 and the release posture (engagement release posture S1) where the solenoid 412 is demagnetized to release the electromagnetic attraction and thereby the swingable plate 42 is moved back by the coil spring so as to perform a given operation (switching between permission and inhibition of a rotation of the latch gear 54 in the above embodiment) is incorporated in the apparatus body 11 to reduce hitting sound of the swingable plate 42 relative to a given stopper, which is caused when the swingable plate 42 is changed in posture from the engaged posture S2 to the engagement release posture S1 in response to demagnetization of the solenoid 421. The solenoid assembly (the braking assembly 40) is mounted to the drive plate 30 fixed to the frame of the apparatus body, and the positioning protrusion 212b integrated with the 3-dimensional frame 20 is used as the stopper.

According to this structure, when the solenoid 412 is magnetized in response to current supplied thereto, the swingable plate 42 is electromagnetically attracted to the solenoid 412 and set in the engaged posture S2. Then, when the solenoid 421 is demagnetized in response to stop of the current supply to the solenoid 412, the swingable plate 42 is changed in posture to the engagement release posture S1 by the coil spring 43. Based on these postural changes, the swingable plate 42 acts to a given mechanism (the latch gear 54 in the above embodiment) to allow the mechanism to perform a given operation (switching between permission and inhibition of a rotation of the latch gear 54 in the above embodiment).

The solenoid assembly (the braking assembly 40) is mounted to the drive plate 30 fixed to the 3-dimensional frame, and the positioning protrusion 212b is integrally attached to the 3-dimensional frame 20. Thus, even if the positioning protrusion 212b is hit by the swingable plate 42 when the swingable plate 42 is changed in posture from the engaged posture S2 to the engagement release posture S1, a mechanical shock due to this hitting is dispersed over and absorbed by the 3-dimensional frame 20 which is fairly heavier than the drive plate 30. This makes it possible to significantly reduce hitting sound as compared with a case where the positioning protrusion 212b is attached to or formed with the drive plate 30, so as to effectively suppress noise generation.

Further, the 3-dimensional frame 20 is made of a synthetic resin. Based on characteristics of a synthetic resin material capable of readily suppressing elastic vibrations as compared to a metal material, a mechanical shock caused when the positioning protrusion 212b is hit by the swingable plate 42 can be absorbed by the synthetic resin frame, to more effectively suppress the generation of hitting sound.

The noise reduction incorporated in the printer 10 as one of image forming apparatuses can effectively suppress hitting sound to be cased when the solenoid device 41 is activated to change the posture of the swingable plate 42 from the engaged posture S2 to the engagement release posture S1. This allows the printer 10 to be free from generation of harsh hitting sound. Thus, even if the printer 10 is placed in a quite office environment, the noise reduction structure can prevent occurrence of a trouble by noise.

In the above embodiment, the solenoid assembly (the braking assembly 40) is used for braking a rotation of the registration roller pair 50 for feeding the sheet P from the sheet storage section 12 to the image forming section 13. Thus, harsh hitting noise which would otherwise be continuously generated in each sheet-feeding operation of the registration roller pair 50 can be eliminated to effectively prevent the printer 10 from disturbing a quite office environment.

The present invention is not limited to the above embodiment. For example, the following modifications may be made therein.

While the noise reduction structure in the above embodiment is applied to an image forming apparatus (printer 10), the application of the noise reduction structure of the present invention is not limited to the image forming apparatus, but the noise reduction structure of the present invention may be applied to various apparatuses using a solenoid assembly.

While the noise reduction structure in the above embodiment is applied to a printer 10 which is one type of image forming apparatuses, the application of the noise reduction structure of the present invention is not limited to the printer, but the noise reduction structure of the present invention may be applied to any other suitable image forming apparatus, such as a copying machine or a facsimile machine.

While the solenoid assembly in the above embodiment is used for operating the latch gear 54 associated with the registration roller pair 50, a mechanism to be operated by the noise reduction structure of the present invention is not limited to the latch gear 54, but the noise reduction structure of the present invention may be applied to any other suitable mechanism designed to be operated by a solenoid assembly.

In the above embodiment, a noise reduction member made, for example, of rubber or a soft synthetic resin, may be attached to one or both of respective contact surfaces of the positioning protrusion 212b and the swingable plate 42. In this case, a mechanical shock caused when the swingable plate 42 hits the positioning protrusion 212b can be reduced to more effectively suppress generation of hitting sound.

In the above embodiment, the positioning protrusion 212b serving as the stopper to be hit by the swingable plate 42 may be formed in a tapered truncated cone shape. In this case, when the swingable plate 42 hits the positioning protrusion 212b, the swingable plate 42 is obliquely brought into point contact with the positioning protrusion 212b. This makes it possible to more effectively suppress generation of hitting sound as compared with line contact.

As described above, in an apparatus having an apparatus body provided with a solenoid assembly which includes a flapper designed to be changed in posture between an electromagnetically attracted posture where a solenoid is magnetized and thereby the flapper is electromagnetically attracted to the solenoid and a release posture where the solenoid is demagnetized and thereby the flapper is moved back by given biasing means and stopped by contact with a given stopper, there is provided a noise reduction structure for reducing hitting sound of the flapper relative to the stopper in connection with the postural change from the electromagnetically attracted posture to the release posture. In the noise reduction structure, the solenoid assembly is mounted to a solenoid-mounting plate fixed to a frame of the apparatus body, and the stopper is provided in the frame in an integrated manner.

According to the noise reduction structure, when the solenoid is magnetized in response to a current supplied thereto, the flapper is electromagnetically attracted to the solenoid and set in the electromagnetically attracted posture. Then, when the current supply to the solenoid is cut off, the solenoid is demagnetized, and thereby the flapper is changed in posture by the biasing means to the release posture where the electromagnetic attraction is released. Based on such postural changes, the flapper will act to a given mechanism so as to allow the mechanism to perform a given operation.

The solenoid assembly is mounted to the solenoid-mounting plate fixed to the frame of the apparatus body. Differently, the stopper is integrally attached to the frame of the apparatus body. Thus, even if the stopper is hit by the flapper when the flapper is changed from the electromagnetically attracted posture to the release posture, a mechanical shock due to this hitting is dispersed over and absorbed by the frame of the apparatus body which is a fairly heavier member than the solenoid-mounting plate. This makes it possible to significantly reduce hitting sound as compared with a case where the stopper is provided in the solenoid-mounting plate, so as to effectively suppress noise generation.

The noise reduction structure may further include a noise reduction member attached to either one or both of respective contact surfaces of the stopper and the flapper. According to this noise reduction structure, when the flapper hits the stopper, the noise reduction member provided in either one or both of the flapper and the stopper can reduce a mechanical shock due to the hitting to suppress the hitting sound at a low level.

Further, a frame made of a synthetic resin may be employed as the frame. In this case, based on characteristics of a synthetic resin material capable of readily suppressing elastic vibrations as compared to a metal material, a mechanical shock caused when the stopper is hit by the flapper can be absorbed by the synthetic resin frame, to more effectively suppress the generation of hitting sound.

The noise reduction structure may be used in an apparatus body of an image forming apparatus designed to allow a toner image formed on an image-supporting member based on given image information to be transferred to a sheet. In this case, the noise reduction structure allows the image forming apparatus to be free from generation of harsh hitting sound. Thus, even if the image forming apparatus is placed in a quite office environment, the noise reduction structure can prevent occurrence of a trouble by noise.

Further, in the image forming apparatus, the solenoid assembly may be used for braking a rotation of a sheet-feeding roller for feeding the sheet. In this case, harsh hitting noise which would otherwise be continuously generated in each sheet-feeding operation of the sheet-feeding roller can be eliminated to effectively prevent the image forming apparatus from disturbing a quite office environment.

This application is based on patent application No. 2005-047824 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. In an apparatus having an apparatus body provided with a solenoid assembly which includes a flapper designed to be changed in posture between an electromagnetically attracted posture where a solenoid is magnetized and thereby the flapper is electromagnetically attracted to the solenoid and a release posture where the solenoid is demagnetized and thereby the flapper is moved back by given biasing means and stopped by contact with a given stopper, a noise reduction structure for reducing hitting sound of the flapper relative to the stopper in connection with the postural change from the an electromagnetically attracted posture to the release posture, wherein:
said solenoid assembly is mounted to a solenoid-mounting plate fixed to a frame of said apparatus body; and
said stopper is provided in said frame in an integrated manner.

2. The noise reduction structure as defined in claim 1, which includes a noise reduction member attached to either one or both of respective contact surfaces of said stopper and said flapper.

3. The noise reduction structure as defined in claim 1, wherein said frame is made of a synthetic resin.

4. The noise reduction structure as defined in claim 1, wherein said apparatus is an image forming apparatus designed to allow a toner image formed on an image-supporting member based on given image information to be transferred to a sheet.

5. The noise reduction structure as defined in claim 4, wherein said solenoid assembly is provided as a means to brake a rotation of a sheet-feeding roller for feeding said sheet.
